(19) United States
(12) Patent Application Publication
(10) Pub. No.: US 2015/0212569 A1
(43) Pub. Date: Jul. 30, 2015

(54) USER SPACE BASED PERFORMANCE STATE SWITCHING OF A PROCESSOR OF A DATA PROCESSING DEVICE

(71) Applicant: NVIDIA Corporation, Santa Clara, CA (US)

(72) Inventors: Shishir Goyal, Pune (IN); Rameshwar Shivbhakta, Pune (IN)

(73) Assignee: NVIDIA Corporation, Santa Clara, CA (US)

(21) Appl. No.: 14/168,019

(22) Filed: Jan. 30, 2014

(51) Int. Cl. G06F 1/32; G06F 9/54

(52) U.S. Cl. CPC G06F 1/3243; G06F 9/542; G06F 9/541

(57) ABSTRACT

A method includes capturing an interaction of a user of a data processing device therewith at a level of a user space through a process executing on the data processing device, and communicating the captured user interaction as an event from the user space to a kernel space associated with an operating system executing on the data processing device. The method also includes incorporating, through the kernel space, the communicated event as a feedback to an algorithm executing on a processor of the data processing device communicatively coupled to a memory. The algorithm is configured to modify a current performance state of the processor based on threshold levels of utilization of the processor. Further, the method includes automatically switching, based on the algorithm execution, the current performance state of the processor to a higher power state or a lower power state thereof additionally in accordance with the communicated event.

### FIELD OF TECHNOLOGY

This disclosure relates generally to data processing devices and, more particularly, to user space based performance state switching of a processor of a data processing device.

### BACKGROUND

A data processing device (e.g., a desktop computer, a laptop computer, a notebook computer, a server, a mobile device) may include a processor communicatively coupled to a memory. The processor may execute a number of application programs thereon. The utilization of the processor due to the aforementioned execution may be monitored through executing, for example, test instructions thereon, based on which a current performance state of the processor may be transitioned to a lower or a higher power state thereof. However, in order to ensure continued presence of the processor in a current state of utilization, the test instructions related to the transitioning may not be executed for a period of time (e.g., 30 seconds). The aforementioned period of time may contribute to a latency associated with the performance state switching.

### SUMMARY

Disclosed are a method, a device and/or a system of user space based performance state switching of a processor of a data processing device.

In one aspect, a method includes capturing an interaction of a user of a data processing device therewith at a level of a user space through a process executing on the data processing device. The user space is associated with locations of a memory of the data processing device in which non-core processes are configured to execute on the data processing device. The user space is distinct from a kernel space. The kernel space is associated with locations of the memory in which a kernel of an operating system is configured to reside and execute on the data processing device. The method also includes communicating, through the execution of the process, the captured user interaction as an event from the user space to the kernel space, and incorporating, through the kernel space, the communicated event as a feedback to an algorithm executing on a processor of the data processing device communicatively coupled to the memory.

The algorithm is configured to modify a current performance state of the processor based on threshold levels of utilization of the processor. Further, the method includes automatically switching, based on the execution of the algorithm, the current performance state of the processor to a higher power state or a lower power state thereof additionally in accordance with the communicated event.

In another aspect, a non-transitory medium, readable through a data processing device and including instructions embodied therein that are executable through the data processing device, is disclosed. The non-transitory medium includes instructions to capture an interaction of a user of the data processing device therewith at a level of a user space through a process executing on the data processing device. The user space is associated with locations of a memory of the data processing device in which non-core processes are configured to execute on the data processing device. The user space is distinct from a kernel space. The kernel space is associated with locations of the memory in which a kernel of an operating system is configured to reside and execute on the data processing device. The non-transitory medium also includes instructions to communicate, through the execution of the process, the captured user interaction as an event from the user space to the kernel space, and instructions to incorporate, through the kernel space, the communicated event as a feedback to an algorithm executing on a processor of the data processing device communicatively coupled to the memory.

The algorithm is configured to modify a current performance state of the processor based on threshold levels of utilization of the processor. Further, the non-transitory medium includes instructions to automatically switch, based on the execution of the algorithm, the current performance state of the processor to a higher power state or a lower power state thereof additionally in accordance with the communicated event.

In yet another aspect, a data processing device includes a memory, and a processor communicatively coupled to the memory. The processor is configured to execute instructions to capture an interaction of a user of the data processing device therewith at a level of a user space through a process executing on the data processing device. The user space is associated with locations of the memory in which non-core processes are configured to execute on the data processing device. The user space is distinct from a kernel space. The kernel space is associated with locations of the memory in which a kernel of an operating system is configured to reside and execute on the data processing device. Through the execution of the process, the captured user interaction is communicated as an event from the user space to the kernel space.

Through the kernel space, the communicated event is incorporated as a feedback to an algorithm executing on the processor. The algorithm is configured to modify a current performance state of the processor based on threshold levels of utilization of the processor. Based on the execution of the algorithm, the current performance state of the processor is configured to be automatically switched to a higher power state or a lower power state thereof additionally in accordance with the communicated event.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE FIGURES

The embodiments of this invention are illustrated by way of example and not limitation in the figures of the accompanying drawings, in which like references indicate similar elements and in which:

FIG. 1 is a schematic view of a data processing device, according to one or more embodiments.

FIG. 2 is a schematic view of a driver component associated with a processor of the data processing device of FIG. 1, according to one or more embodiments.

FIG. 3 is a schematic view of the data processing device of FIG. 1 in which user activity is tracked, according to one or more embodiments.

FIG. 4 is a schematic view of an alternate implementation of the data processing device of FIG. 1 involving a performance state switching algorithm executing on the processor thereof, according to one or more embodiments.

FIG. 5 is a process flow diagram detailing the operations involved in user space based performance state switching of the processor of the data processing device of FIGS. 1, 3 and 4, according to one or more embodiments.

Other features of the present embodiments will be apparent from the accompanying drawings and from the detailed description that follows.

### DETAILED DESCRIPTION

Example embodiments, as described below, may be used to provide a method, a device and/or a system of user space based performance state switching of a processor of a data processing device. Although the present embodiments have been described with reference to specific example embodiments, it will be evident that various modifications and changes may be made to these embodiments without departing from the broader spirit and scope of the various embodiments.

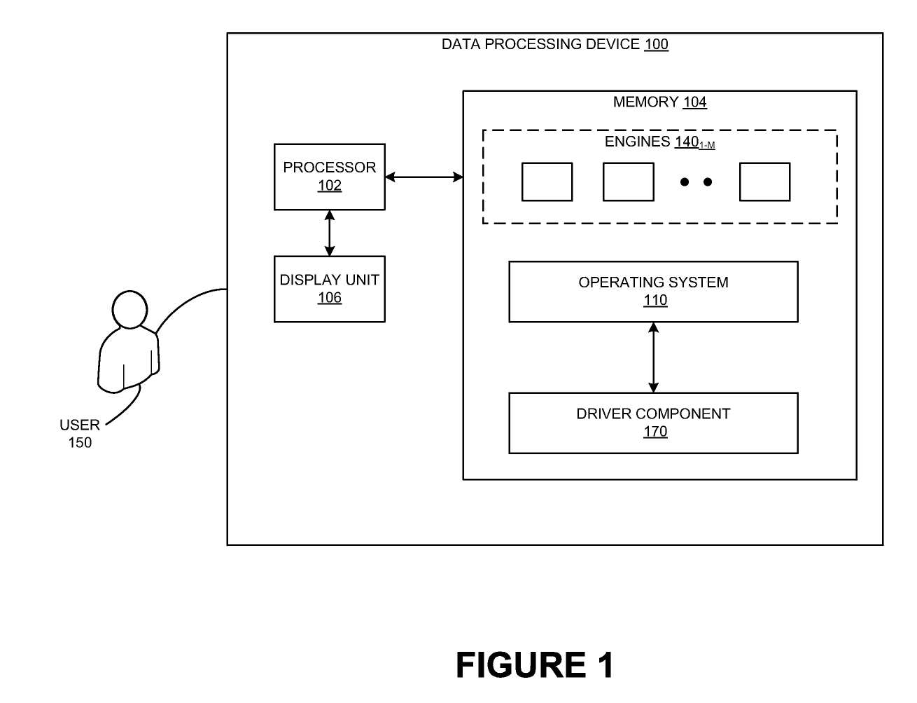

FIG. 1 shows a data processing device 100, according to one or more embodiments. In one or more embodiments, data processing device 100 may represent various forms of digital computers such as a laptop, a desktop, a workstation, a notebook computer, a netbook, a Personal Digital Assistant (PDA), a server and a mobile device (e.g., a mobile phone, a tablet). Other examples of data processing device 100 are within the scope of the exemplary embodiments discussed herein. In one or more embodiments, data processing device 100 may include a processor 102 (e.g., a Central Processing Unit (CPU), a Graphics Processing Unit (GPU) and/or another processor such as a microcontroller) communicatively coupled to a memory 104 (e.g., a volatile memory and/or a non-volatile memory), processor 102 being configured to address storage locations in memory 104. In one or more embodiments, output data associated with processing through processor 102 may be input to a multimedia processing unit (not shown) configured to perform encoding/decoding associated with the data. In one or more embodiments, the output of the multimedia processing unit may be rendered on a display unit 106 (e.g., Liquid Crystal Display (LCD) display, Cathode Ray Tube (CRT) monitor); FIG. 1 shows processor 102 being communicatively coupled to display unit 106.

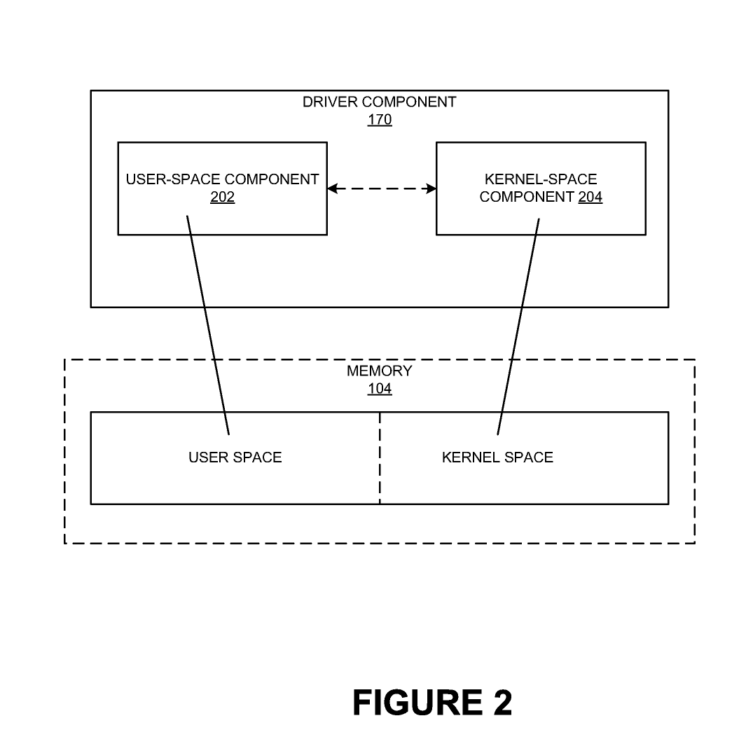

It is obvious that an operating system 110 may execute on data processing device 100. FIG. 1 shows operating system 110 as being stored in memory 104 (e.g., non-volatile memory). In one or more embodiments, processor 102 may be in an idle state; a driver component (e.g., a software driver) associated with processor 102 and/or operating system 110 may initiate detection of states of utilization of processor 102. FIG. 1 shows driver component 170 associated with processor 102 stored in memory 104. FIG. 2 shows driver component 170 in detail, according to one or more embodiments. In one or more embodiments, driver component 170 may include a user-space component 202 and a kernel-space component 204.

In one or more embodiments, user-space component 202 may reside in a user space (e.g., associated with a user 150 of data processing device 100) of a system memory (e.g., memory 104) associated with operating system 110 and kernel-space component 204 may reside in a kernel space of the system memory. In one or more embodiments, the kernel space is associated with memory locations in which the kernel, or, the core of operating system 110, resides and executes; the kernel (not shown) may provide services therefrom. In one or more embodiments, the user space may be associated with memory locations in which non-core processes (e.g., application programs) execute. In one or more embodiments, a key responsibility of the kernel may be to prevent individual processes from interfering with one another.

In an example embodiment, performance of data processing device 100 may be indicated through power consumption and capability states of processor 102. The performance states may be represented as Pₓ, where x=0 . . . N. In the P₀ state, data processing device 100/processor 102 may be at a maximum performance capability thereof; the aforementioned state may also be associated with maximum power consumption. The P₁ state may be associated with a lower performance and power consumption than the P₀ state. In accordance with the hierarchy, the P_{N} state may be associated with the lowest performance and the lowest power consumption. In one example implementation, there may be a maximum of 16 performance states; in other words, N=15.

Typically, performance state switching may be completely based on utilization of processor 102. Processor 102 may execute a number of engines 140_{1-M} (e.g., video memory engine, display engine; engines 140_{1-M} are shown as being stored in memory 104 to be executed on processor 102) thereon. Here, kernel-space component 204 may set up an idle counter (not shown) associated with each engine 140_{1-M} to count clock cycles where the each engine 140_{1-M} is not completely idle. Kernel-space component 204 may then poll the idle counters associated with the number of engines 140_{1-M} to enable calculation of resource (e.g., processor 102, memory 104 including portion (e.g., frame buffer) thereof associated with video/display related processing) utilization associated with data processing device 100. An example of resource utilization may be indicated by instructions executed on processor 102 per clock cycle.

The idle counter mentioned above associated with the each engine 140_{1-M} may be incremented with increasing number of clock cycles and a count value thereof read from a register (not shown) associated with processor 102. The performance monitoring may incorporate one or more threshold values associated with the resource (e.g., processor 102) utilization stored in memory 104. If the resource utilization determined is lesser than a lower bound to the one or more threshold values, kernel-space component 204 may trigger switching of a current performance state to a lower power state thereof. The level of switching may depend on the amount by which the resource utilization falls below the lower bound. In one example scenario, the performance state may be switched from P₀ to P₄ instead of P₀ to P₁.

If the resource utilization determined is higher than an upper bound to the one or more threshold values, kernel-space component 204 may trigger switching of the current performance state to a higher power state thereof. For example, the performance state may be switched from P₅ to P₁, P₅ to P₄, P₇ to P₄ etc.

The switching of performance states discussed above may completely rely on utilization of processor 102. The aforementioned process/processes may involve waiting for a period of time (e.g., 30 seconds) before triggering the switching of the performance states to ensure the continued existence of the resource (e.g., processor 102) in the current state of utilization thereof. As kernel-space component 204 (or, kernel-space driver stack) is “closer” to hardware than user 150 and is unaware of application programs executing in the user space, the waiting period of time may be required to ensure consistency of the utilization of processor 102 prior to the switching thereof.

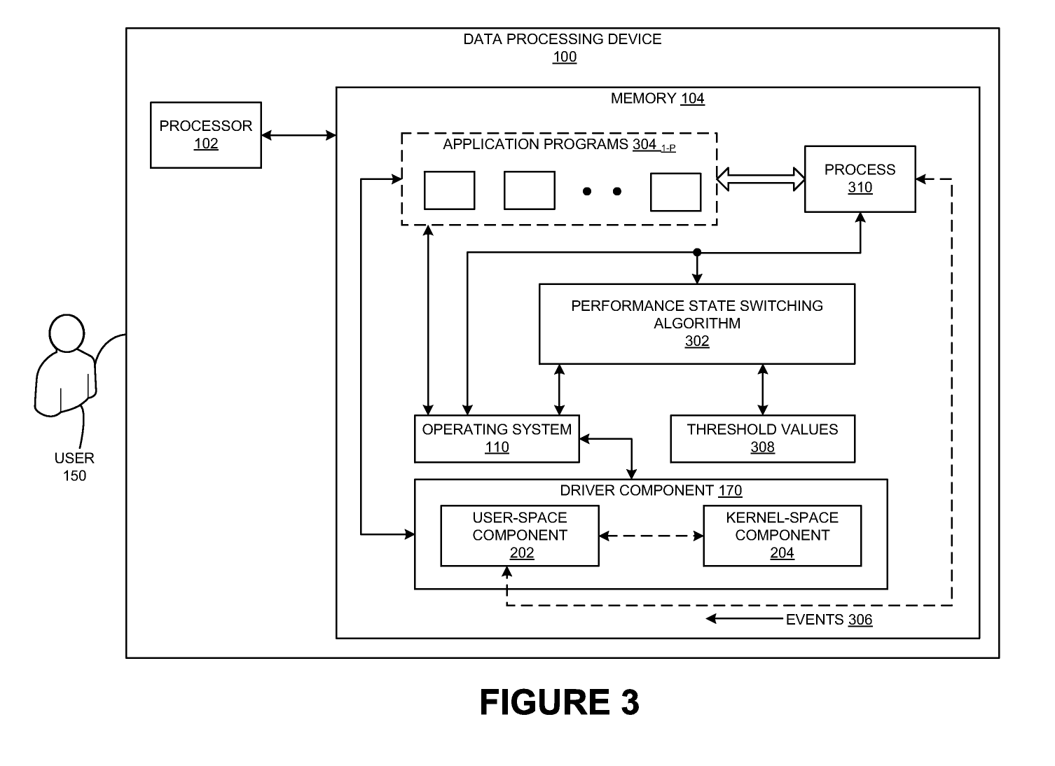

FIG. 3 shows data processing device 100 in which activity in the user space is tracked, according to one or more embodiments. In one or more embodiments, processor 102 may execute one or more performance state switching algorithms (e.g., performance state switching algorithm 302 shown stored in memory 104 in FIG. 3 to be executed on processor 102) thereon. Further, FIG. 3 shows a number of application programs 304_{1-P} being stored in memory 104 to be executed on processor 102. In one or more embodiments, activity of user 150 on data processing device 100 may be monitored through user-space component 202. Examples of activity of user 150 may include maximizing/minimizing an application program 304_{1-P}, suspending/resuming an application program 304_{1-P} and exiting an application program 304_{1-P}.

In one or more embodiments, the activity of user 150 may be communicated to kernel-space component 204 in the form of events (e.g., through translatable escape calls, Input/Output (I/O) control calls). FIG. 3 shows activity of user 150 being communicated to user-space component 202 as events 306 to be translated therein. In one or more embodiments, kernel-space component 204 may then interpret events 306 and incorporate said interpretation as a feedback into performance state switching algorithm 302. In one or more embodiments, based on the interpretation of events 306 and resource (e.g., processor 102) utilization threshold values (e.g., threshold values 308 shown as being stored in memory 104) discussed above, kernel-space component 204 may decide on switching a current performance state of processor 102 to a higher power state or a lower power state thereof in accordance with execution of performance state switching algorithm 302 on data processing device 100/processor 102.

For example, execution of several application programs 304_{1-P} or a computationally intensive application program 304_{1-P} may cause communication of one or more events 306 between user-space component 202 and kernel-space component 204. The incorporation of the one or more events 306 as a feedback into performance state switching algorithm 302 may cause kernel-space component 204 to interpret the one or more events 306 as processor 102 requiring increased power states for optimal execution of the several application programs 304_{1-P} or the computationally intensive application program 304_{1-P} thereon. Thus, kernel-space component 204 may trigger the switching of a current performance state of processor 102 to a higher power state thereof.

In one or more embodiments, kernel-space component 204 may include a process 310 associated therewith to enable capturing of activity of user 150 on data processing device 100. In one or more embodiments, process 310 may then enable communication of events 306 between user-space component 202 and kernel-space component 204. It should be noted that process 310 may be part of an application program 304_{1-P} (or, user-space component 202) executing on data processing device 100 or separate therefrom. FIG. 3 shows process 310 being at a level of application programs 304_{1-P}.

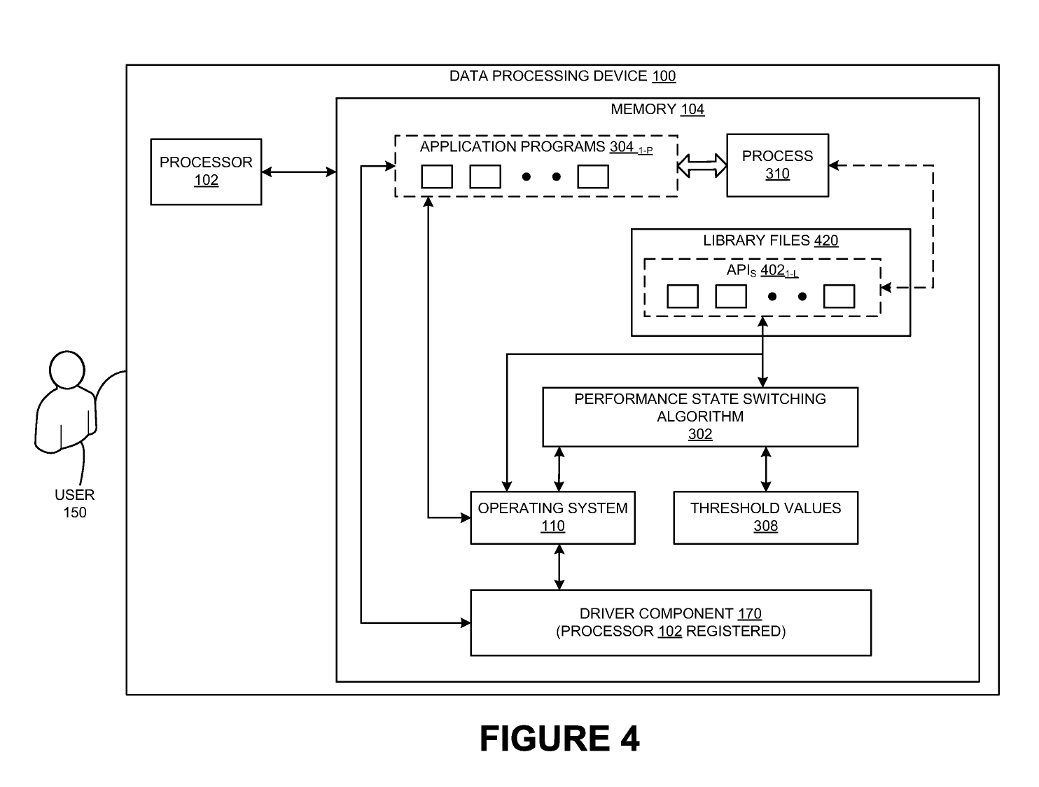

FIG. 4 shows an alternate implementation of concepts discussed herein through performance state switching algorithm 302, according to one or more embodiments. In one or more embodiments, performance state switching algorithm 302 may include Application Programming Interfaces (APIs) 402_{1-L} (e.g., shown packaged along with library files 420 in memory 104) associated therewith; said APIs 402_{1-L} may define interactions between components (e.g., software components) of performance state switching algorithm 302, and interaction between process 310 and performance state switching algorithm 302. In one or more embodiments, upon loading of driver component 170 onto data processing device 100, processor 102 may first be registered with driver component 170. In one or more embodiments, based on the registration, performance state switching algorithm 302 may then be automatically configured to receive interactions of user 150 as input thereto, following which processor 102 (e.g., based on execution of performance state switching algorithm 302) decides whether to switch a current performance state to a higher/lower power state.

FIGS. 3-4 discuss two specific implementations involving concepts associated with the exemplary embodiments, viz. one involving tracking through user-space component 202 and another involving directly inputting interactions of user 150 to performance state switching algorithm 302 (e.g., through exposing appropriate APIs 402_{1-L}). Other implementations and reasonable variations are within the scope of the exemplary embodiments discussed herein. Also, instructions associated with driver component 170 (or, just user-space component 202), process 310, performance state switching algorithm 302 and/or APIs 402_{1-L} may be embodied in a non-transitory medium (e.g., Compact Disc (CD), Digital Video Disc (DVD), Blu-ray disc®, hard drive) readable through data processing device 100/processor 102 and executable therethrough. The aforementioned instructions may additionally (or, optionally) be packaged with operating system 110 and/or one or more application programs 304_{1-P}.

Further, it should be noted that driver component 170 (e.g., kernel-space component 204) may also enable power gating one or more engine(s) 140_{1-M} executing on processor 102 in conjunction with transitioning processor 102 to a lower power performance state thereof. In one alternate embodiment, the aforementioned power gating may be part of the transitioning of the current performance state of processor 102 to the lower power state thereof. Similarly, the transitioning of processor 102 to a higher power performance state thereof may involve restoring the power-gated one or more engine(s) 140_{1-M}. Again, the aforementioned restoration may be part of the transitioning of the current performance state of processor 102 to the higher power state thereof.

Thus, in one or more embodiments, performance state switching decisions may be taken quicker through processor 102. In one or more embodiments, therefore, latency in the performance state switching may be reduced; consequently, a life of a battery (example power source) of data processing device 100 may be increased. It should be noted that user interactive scenarios may not be limited to those discussed above. Other user interactive scenarios incorporated into performance state switching algorithm 302 are within the scope of the exemplary embodiments discussed herein.

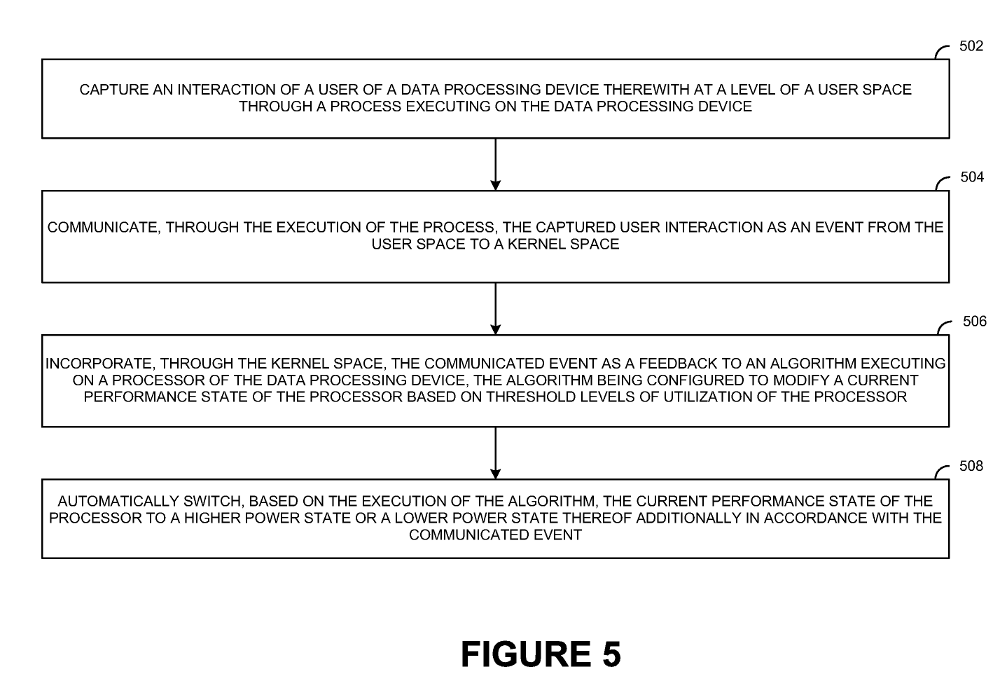

FIG. 5 shows a process flow diagram detailing the operations involved in user space based performance state switching of processor 102, according to one or more embodiments. In one or more embodiments, operation 502 may involve capturing an interaction of user 150 of data processing device 150 therewith at a level of a user space through process 310. In one or more embodiments, the user space may be associated with locations of memory 104 in which non-core processes are configured to execute on data processing device 100. In one or more embodiments, the user space may be distinct from a kernel space. In one or more embodiments, the kernel space may be associated with locations of memory 104 in which a kernel of operating system 110 is configured to reside and execute on data processing device 100.

In one or more embodiments, operation 504 may involve communicating, through the execution of process 310, the captured user interaction as an event (e.g., event 306) from the user space to the kernel space. In one or more embodiments, operation 506 may involve incorporating, through the kernel space, the communicated event as a feedback to an algorithm (e.g., performance state switching algorithm 302) executing on processor 102. In one or more embodiments, the algorithm may be configured to modify a current performance state of processor 102 based on threshold levels of utilization of processor 102.

In one or more embodiments, operation 508 may then involve automatically switching, based on the execution of the algorithm, the current performance state of processor 102 to a higher power state or a lower power state thereof additionally in accordance with the communicated event.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a non-transitory machine-readable medium). For example, the various electrical structures and methods may be embodied using transistors, logic gates, and electrical circuits (e.g., Application Specific Integrated Circuitry (ASIC) and/or Digital Signal Processor (DSP) circuitry).

In addition, it will be appreciated that the various operations, processes, and methods disclosed herein may be embodied in a non-transitory machine-readable medium and/or a machine accessible medium compatible with a data processing system (e.g., data processing device 100), and may be performed in any order (e.g., including using means for achieving the various operations).

Accordingly, the specification and drawings are to be regarded in an illustrative rather than a restrictive sense.

What is claimed is:

1. A method comprising:
capturing an interaction of a user of a data processing device therewith at a level of a user space through a process executing on the data processing device, the user space being associated with locations of a memory of the data processing device in which non-core processes are configured to execute on the data processing device, the user space being distinct from a kernel space, and the kernel space being associated with locations of the memory in which a kernel of an operating system is configured to reside and execute on the data processing device;
communicating, through the execution of the process, the captured user interaction as an event from the user space to the kernel space;
incorporating, through the kernel space, the communicated event as a feedback to an algorithm executing on a processor of the data processing device communicatively coupled to the memory, the algorithm being configured to modify a current performance state of the processor based on threshold levels of utilization of the processor; and
automatically switching, based on the execution of the algorithm, the current performance state of the processor to one of: a higher power state and a lower power state thereof additionally in accordance with the communicated event.

2. The method of claim 1, further comprising:
triggering the execution of the process through a driver component associated with the processor in the user space; and
communicating the event between the driver component in the user space and a driver component associated with the processor in the kernel space.

3. The method of claim 2, comprising determining, through the driver component in the kernel space, whether the automatic switching of the current performance state of the processor is required.

4. The method of claim 1, further comprising:
registering the processor with a driver component;
providing an Application Programming Interface (API) associated with the algorithm, the API defining interaction between software components of the algorithm and an interaction between the process and the algorithm; and
providing a capability to automatically capture the user interaction and to automatically switch the current performance state of the processor based on the registering of the processor with the driver component.

5. The method of claim 1, wherein the automatic switching of the current performance state of the processor to the lower power state thereof further comprises power gating at least one engine executing on the processor.

6. The method of claim 4, comprising at least one of:
providing the process at a level of an application program executing on the data processing device; and
providing the API as part of a library file in the memory.

7. The method of claim 1, comprising capturing a state of an application program executing on the data processing device as the user interaction.

8. A non-transitory medium, readable through a data processing device and comprising instructions embodied therein that are executable through the data processing device, comprising:
instructions to capture an interaction of a user of the data processing device therewith at a level of a user space through a process executing on the data processing device, the user space being associated with locations of a memory of the data processing device in which non-core processes are configured to execute on the data processing device, the user space being distinct from a kernel space, and the kernel space being associated with locations of the memory in which a kernel of an operating system is configured to reside and execute on the data processing device;
instructions to communicate, through the execution of the process, the captured user interaction as an event from the user space to the kernel space;
instructions to incorporate, through the kernel space, the communicated event as a feedback to an algorithm executing on a processor of the data processing device communicatively coupled to the memory, the algorithm being configured to modify a current performance state of the processor based on threshold levels of utilization of the processor; and
instructions to automatically switch, based on the execution of the algorithm, the current performance state of the processor to one of: a higher power state and a lower power state thereof additionally in accordance with the communicated event.

9. The non-transitory medium of claim 8, further comprising:
instructions to trigger the execution of the process through a driver component associated with the processor in the user space; and
instructions to communicate the event between the driver component in the user space and a driver component associated with the processor in the kernel space.

10. The non-transitory medium of claim 9, comprising instructions to determine, through the driver component in the kernel space, whether the automatic switching of the current performance state of the processor is required.

11. The non-transitory medium of claim 8, further comprising:
instructions to register the processor with a driver component;
instructions to provide an API associated with the algorithm, the API defining interaction between software components of the algorithm and an interaction between the process and the algorithm; and
instructions to provide a capability to automatically capture the user interaction and to automatically switch the current performance state of the processor based on the registering of the processor with the driver component.

12. The non-transitory medium of claim 8, wherein the instructions to automatically switch the current performance state of the processor to the lower power state thereof further comprise instructions to power gate at least one engine executing on the processor.

13. The non-transitory medium of claim 8, comprising instructions to capture a state of an application program executing on the data processing device as the user interaction.

14. A data processing device comprising:
a memory; and
a processor communicatively coupled to the memory, the processor being configured to execute instructions to capture an interaction of a user of the data processing device therewith at a level of a user space through a process executing on the data processing device, the user space being associated with locations of the memory in which non-core processes are configured to execute on the data processing device, the user space being distinct from a kernel space, and the kernel space being associated with locations of the memory in which a kernel of an operating system is configured to reside and execute on the data processing device,
wherein, through the execution of the process, the captured user interaction is communicated as an event from the user space to the kernel space,
wherein, through the kernel space, the communicated event is incorporated as a feedback to an algorithm executing on the processor, the algorithm being configured to modify a current performance state of the processor based on threshold levels of utilization of the processor, and
wherein, based on the execution of the algorithm, the current performance state of the processor is configured to be automatically switched to one of: a higher power state and a lower power state thereof additionally in accordance with the communicated event.

15. The data processing device of claim 14, further comprising:
a driver component associated with the processor in the user space to trigger the execution of the process; and
a driver component associated with the processor in the kernel space, the event being communicated between the driver component in the user space and the driver component in the kernel space.

16. The data processing device of claim 15, wherein the driver component in the kernel space is configured to determine whether the automatic switching of the current performance state of the processor is required.

17. The data processing device of claim 14, further comprising:
a driver component to which the processor is configured to registered; and
an API associated with the algorithm, the API defining interaction between software components of the algorithm and an interaction between the process and the algorithm,
wherein, based on the registration of the processor with the driver component, the data processing device is provided with a capability to automatically capture the user interaction and to automatically switch the current performance state of the processor.

18. The data processing device of claim 14, wherein the algorithm is additionally configured to power gate at least one engine executing on the processor as part of the automatic switching of the current performance state of the processor to the lower power state thereof.

19. The data processing device of claim 17, wherein at least one of:
the process is provided at a level of an application program executing on the data processing device, and
the API is provided as part of a library file in the memory.

20. The data processing device of claim 14, wherein a state of an application program executing on the data processing device is configured to be captured as the user interaction.
